(19) United States
(12) Patent Application Publication
(10) Pub. No.: US 2024/0191086 A1
(43) Pub. Date: Jun. 13, 2024

(54) COATING FOR A FLOOR ELEMENT AND A FLOOR ELEMENT FOR SOUND REDUCTION

(71) Applicant: Walter Stranak, Lauda-Königshofen (DE)

(72) Inventor: Walter Stranak, Lauda-Königshofen (DE)

(21) Appl. No.: 18/532,833

(22) Filed: Dec. 7, 2023

(30) Foreign Application Priority Data
Dec. 8, 2022 (DE) 10 2022 132 637.3

(51) Int. Cl. C09D 7/65; C09D 7/40; C09D 101/16; C09D 167/06; C09D 175/04; C09D 197/00; E04F 15/04; E04F 15/18

(52) U.S. Cl. CPC C09D 7/65; C09D 7/69; C09D 101/16; C09D 167/06; C09D 175/04; C09D 197/007; E04F 15/041; E04F 15/181

(57) ABSTRACT

What is disclosed is a coating for a floor element comprising a coating varnish for application to the floor element, the coating varnish comprising a cork powder.

### CROSS-REFERENCE TO RELATED APPLICATIONS

This patent application claims priority to German utility patent application number 10 2022 132 637.3 filed Dec. 8, 2022, and titled “Coating for a floor element and a floor element for sound reduction”. The subject matter of patent application number 10 2022 132 637.3 is hereby incorporated by reference in its entirety.

### STATEMENT REGARDING FEDERALLY SPONSORED RESEARCH OR DEVELOPMENT

### Not Applicable.

### INCORPORATION BY REFERENCE OF MATERIAL SUBMITTED ON A COMPACT DISC

Not Applicable.

### FIELD OF THE INVENTION

The present invention relates to a coating for a floor element and a floor element for sound reduction.

### BACKGROUND

The use of floor elements is widespread in the form of floor panels. For example, a sandwich-type panel consisting of several layers of different materials can be used. In this regard, the different layers fulfil various purposes, such as sound or heat insulation, improved mechanical strength or weather resistance. Special interlocking structures allow panels to be used to quickly produce closed floor surfaces.

It is also known to produce cork floors consisting of cork elements, for example. Cork is water-repellent and therefore very easy to care for. Cork floors do not absorb dust or mites. The cork floor is either bonded to the subfloor or laid as a floating floor, depending on the type of cork floor, whereby tiles are usually bonded and finished parquet is laid as a floating floor.

It is common practice to lay a layer of cork under the panels for heat and sound insulation. Floor panels are laid directly on top of fully bonded cork. Cork is often laid under laminate to serve as a full-surface footfall sound insulation layer.

DE 697 13 272 T2, DE 94 08 303 U1, DE 20 2011 110 057 U1 and DE 10 2007 019 978 B3 are also known.

A drawback of known solutions is that a separate layer must be laid at great expense for footfall sound insulation. This applies in particular if a layer of cork is bonded.

### SUMMARY

It is the object of the present invention to provide a coating for a floor element and a floor element for sound reduction which overcomes the drawbacks of the prior art and, in particular, is easy to manufacture.

This object is achieved by a coating for a floor element for sound reduction and a floor element according to the respective independent claim. Advantageous embodiments form the subject-matter of the respective claims.

The invention encompasses a coating for a floor element comprising a coating varnish for application to the floor element, wherein the coating varnish comprises a cork powder. The coating varnish is an easily workable/processable binder for the cork powder homogeneously distributed therein. This combination has the particular advantage of being easy to process by machine. Surprisingly, it has been shown that the sound properties of floor elements are significantly and positively modified by the back coating proposed here.

### BRIEF DESCRIPTION OF THE DRAWINGS

In the following, the invention is further explained below with reference to the examples shown in the accompanying drawings:

FIG. 1 shows a coating for sound reduction applied to a floor element; and

FIG. 2 shows a detailed view of the coating layer from FIG. 1.

### DETAILED DESCRIPTION

According to an advantageous aspect, the coating varnish has a thickness in the range of 0.05 mm to 1.5 mm. Such layer thicknesses can advantageously be applied in one step. Advantageously, the respective coating varnish has a viscosity that is suitable for machine application, for example by means of an application roller. The range from 0.05 mm to 0.3 mm is particularly preferable for this application.

Advantageously, the coating varnish consists only of natural components, synthetic components or mixtures thereof. Depending on the requirements, a cost-effective or environmentally friendly coating can thus be produced in order to create application-specific coatings (e.g., suitable for living spaces.

The coating varnish is preferably a synthetic resin, alkyd resin, polyurethane or nitrocellulose varnish. Known coating application methods can be employed for these examples. For example, a coating varnish may comprise aqueous varnishes, synthetic varnishes such as polyester, polyurethane, epoxy, acrylates, etc.

Advantageously, the cork powder has a grain size in the range of 0.1 mm to 1 mm. This grain size allows easy workability/processability and has ensured the corresponding sound reduction. The range from 0.1 mm to 0.3 mm is particularly preferable for mechanical processing.

Cork powder further preferably has a grain size of a single grain size or different grain sizes. The range of grain sizes used can be adapted with regard to the desired workability. In industrial processing, the use of a single grain size realizes good and consistent quality.

The proportion of cork powder in the coating varnish is particularly preferably in the range from 5 vol % to 50 vol %.

According to a further aspect, the invention relates to a floor element comprising a coating varnish for application to the floor element, wherein the coating varnish comprises a cork powder, and wherein the coating varnish is applied in at least one layer on a side of the floor element opposite a visible side. The coating varnish is applied during the manufacture of the floor element or during processing.

According to an advantageous aspect, the coating varnish is applied in a thickness of 0.05 mm to 0.3 mm.

Particularly preferably, the coating varnish is applied in a single layer over a full surface of the floor element (in one step).

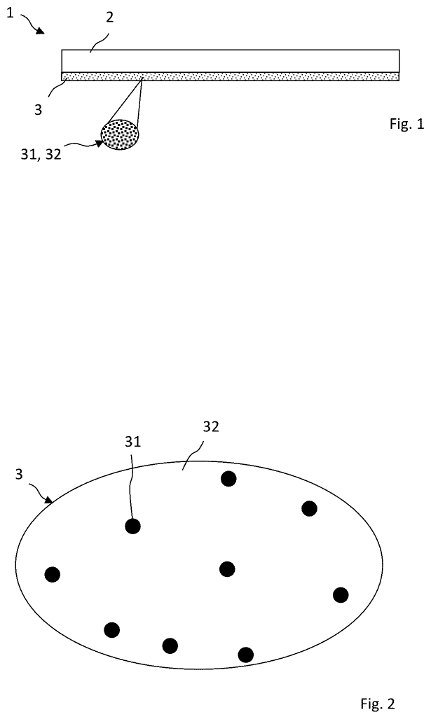

In FIG. 1, a flat floor element 1 (or the section of a floor covering) is shown in lateral cross-section. The upper visible side 2 can be designed according to the desired appearance, for example with a veneer. In principle, the type of floor element 1 is not limited in terms of shape and size. However, it is particularly advantageous if it is made on the basis of wood, i.e., it comprises at least one layer made of wood.

On the lower side of the floor element 1, opposite the visible side, there is a coating 3 according to the invention for improving the properties with respect to sound occurring in the installed floor. The coating 3 comprises a coating varnish 31 for application to the floor element 1. In the example shown, the coating varnish 3 is applied in exactly one layer on the side of the floor element 1 opposite the visible side.

The coating varnish 31 comprises a cork powder 32 or the cork powder 32 is incorporated (dispersed or uniformly distributed) in the coating varnish 31 in order to modify the sound properties of a floor designed with the floor elements 1, in particular with regard to footfall sound.

In the example shown, the coating varnish 31 is applied in a thickness of 0.05 mm to 0.3 mm. The coating varnish 31 preferably consists only of natural components, synthetic components but can also consist of mixtures thereof. For example, the coating varnish 31 is a synthetic resin, alkyd resin, polyurethane or nitrocellulose varnish.

In the example shown, the cork powder 32 has a grain size in the range from 0.1 mm to 1 mm. Advantageously, the cork powder 32 has a grain size of a single grain size, but predetermined varieties of different grain sizes can also be used.

The proportion of cork powder 32 in the coating varnish 31 is in the range from 5 vol % to 50 vol %.

FIG. 2 shows an enlarged detailed view of the coating 3 from FIG. 1, in which a section is shown greatly enlarged, as it is part of the coating. The coating varnish 31 comprises the cork powder 32 uniformly distributed in a single grain size.

1. Coating for a floor element comprising a coating varnish for application to the floor element, wherein the coating varnish comprises a cork powder.

2. Coating according to claim 1, wherein the coating varnish has a thickness in the range from 0.05 mm to 1.5 mm.

3. Coating according to claim 1, wherein the coating varnish consists only of natural components, synthetic components or mixtures thereof.

4. Coating according to claim 3, wherein the coating varnish is a synthetic resin, alkyd resin, polyurethane or nitrocellulose varnish.

5. Coating according to claim 1, wherein the cork powder has a grain size in the range from 0.1 mm to 1 mm.

6. Coating according to claim 5, wherein the cork powder has a grain size of a single grain size or different grain sizes.

7. Coating according to claim 1, wherein the proportion of cork powder in the coating varnish is in the range from 5 vol % to 50 vol %.

8. Floor element comprising a coating varnish for application to the floor element, wherein the coating varnish comprises a cork powder, and wherein the coating varnish is applied in at least one layer on a side of the floor element opposite a visible side.

9. Floor element according to claim 8, wherein the coating varnish has been applied in a thickness of 0.05 mm to 0.3 mm.

10. Floor element according to claim 8, wherein the coating varnish has been applied in a single layer.
